(19) United States
(12) Patent Application Publication
(10) Pub. No.: US 2006/0022803 A1
(43) Pub. Date: Feb. 2, 2006

(54) Semiconductor device and IC tag for transmitting/receiving data in radio communication

(75) Inventors: Kazuhiro Akiyama, Kanagawa (JP); Hatsuhide Igarashi, Kanagawa (JP); Seiichi Okamoto, Kanagawa (JP); Toshiyuki Miyashita, Kanagawa (JP); Kazumi Seki, Kanagawa (JP); Tatsuya Uchino, Kanagawa (JP); Shigeki Kajimoto, Osaka (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/191,041

(22) Filed: Jul. 28, 2005

(30) Foreign Application Priority Data
Jul. 29, 2004 (JP) 2004-222599

(51) Int. Cl. H04Q 5/22; H04B 7/24; G06K 19/06; G08B 13/14

(52) U.S. Cl. 340/10.34; 235/492; 455/39; 340/572.1

(57) ABSTRACT

A semiconductor device, comprises a receive circuit for generating receive data from received radio signals, a power supply voltage generation circuit for generating power supply voltage based on the received radio signals, a control circuit for performing logical processing based on the received data, a transmission circuit for generating radio signals including transmission data and transmitting the radio signals via an antenna and an oscillation circuit, which is operated using the power supply voltage generated by the power supply voltage generation circuit, for generating a predetermined frequency of clocks.

### BACKGROUND OF THE INVENTION

1. Field of the Invention

The present invention relates to a semiconductor device, and more particularly to a semiconductor device and an IC tag for transmitting/receiving data in radio communication with a reader/writer.

2. Description of the Related Art

Recently in physical distribution management at factories and in stock control at retail stores, RFID (Radio Frequency IDentification) technology is receiving attention. This is a technology for attaching a tag having an IC, in which the identification information on a product is written, to the product and reading the information by radio antenna.

For this technology, a reader/writer and a tag for RFID (hereafter called IC tag) are used. The reader/writer is for transmitting modulated radio signals including data and carrier to an IC tag, and receiving the radio signals transmitted from the IC tag. The IC tag demodulates the received radio signals, and executes processing based on the received data. The IC tag also transmits the reply to the received data to the reader/writer. Here the IC tag is an IC chip and an antenna which are integrated, for example.

Among IC tags, an IC tag called a passive type receives radio signals from the reader/writer and the power supply voltage is generated by these radio signals (see Udo Karthaus, et al, “Fully Integrated Passive UHF RFID Transponder IC with 16.7-μW Minimum RF Input Power”, IEEE Journal of Solid-State Circuits, Vol. 38, No. 10, October 2003, pp. 1602-1608). In other words, in the case of a passive type IC tag, the radio signals used for communication with the reader/writer are used for supplying power and transmitting/receiving data.

In this series of operations, the data transmitted from the IC tag to the reader/writer is data in which the identification information is binarized. When this data is transmitted to the reader/writer, a signal called a sub-carrier may be used to guarantee the demodulation of data at the reader/writer side. In other words, the radio signals which are transmitted from the IC tag to the reader/writer are not only the carrier and data, but may have a sub-carrier, that is signals of which frequency is lower than the carrier, superimposed.

Conventionally signals corresponding to the sub-carrier are generated by a divider installed in the IC tag. In other words, the carrier received from the reader/writer is divided, and signals having a frequency lower than that of the carrier are generated.

However as the frequency of the carrier increases, the size of the divider for generating the necessary frequency also increases, and it is becoming difficult to generate signals corresponding to the sub-carrier by dividing the carrier in the IC tag. Also an increase in size of the divider increases the power consumption by the divider, and this increases the power consumed in the IC tag.

### SUMMARY OF THE INVENTION

According to a first aspect of the invention a semiconductor device, comprises a receive circuit for generating receive data from received radio signals, a power supply voltage generation circuit for generating power supply voltage based on the received radio signals, a control circuit for performing logical processing based on the received data, a transmission circuit for generating radio signals including transmission data and transmitting the radio signals via an antenna and an oscillation circuit, which is operated using the power supply voltage generated by the power supply voltage generation circuit, for generating a predetermined frequency of clocks.

### BRIEF DESCRIPTION OF THE DRAWINGS

The above and other objects, advantages and features of the present invention will be more apparent from the following description taken in conjunction with the accompanying drawings, in which:

FIG. 1 is a diagram depicting the RFID system comprising an IC tag and a reader/writer according to an embodiment of the present invention;

FIG. 2 is a diagram depicting the configuration of the IC tag according to an embodiment of the present invention;

FIG. 3A and FIG. 3B are diagrams depicting the waveforms of transmission data according to an embodiment of the present invention;

FIG. 3C is a diagram depicting the waveforms of sampling clock according to an embodiment of the present invention;

FIG. 3D is a diagram depicting pulse for modulation according to an embodiment of the present invention;

FIG. 4 is a diagram depicting the configuration of the output circuit according to an embodiment of the present invention;

FIG. 5 is a diagram depicting the configuration of the modulation circuit according to an embodiment of the present invention;

FIG. 6A is a diagram depicting waveform of the pulse for modulation according to an embodiment of the present invention;

FIG. 6B is a diagram depicting waveform of the ASK modulation waves according to an embodiment of the present invention;

FIG. 7 is a diagram depicting the spectrum distribution of the ASK modulation wave of the present invention;

FIG. 8 is a circuit diagram depicting an example of the oscillation circuit of the present invention;

FIG. 9 is a flow chart depicting the adjustment of frequency of the oscillation circuit of the present invention;

FIG. 10 is a circuit diagram depicting another example of the present invention; and

FIG. 11 is a circuit diagram depicting details of the oscillation circuit shown in FIG. 10.

### PREFERRED EMBODIMENT OF THE INVENTION

The invention will be now described herein with reference to illustrative embodiments. Those skilled in the art will recognize that many alternative embodiments can be accomplished using the teachings of the present invention and that the invention is not limited to the embodiments illustrated for explanatory purposed.

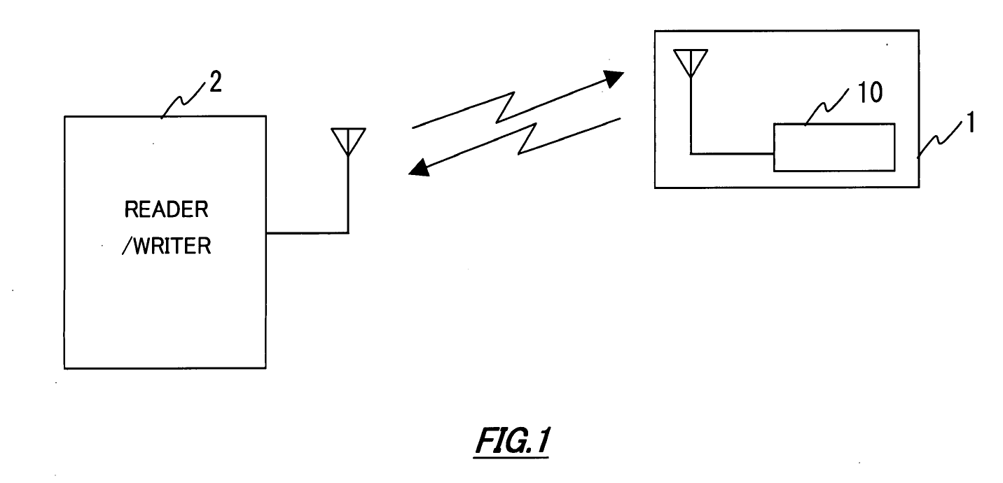

Embodiments of the present invention will now be described with reference to the drawings. FIG. 1 is a diagram depicting the RFID system according to an embodiment. This system comprises a tag 1 for RFID and a reader/writer 2. In the present embodiment, it is assumed that the IC tag 1 is a system which communicates with the reader/writer 2 at a high frequency, such as the 2.45 GHz band.

The reader/writer 2 is a device which transmits the modulated radio signals, including the data and carrier (2.45 GHz), to the IC tag 1, and receives the radio signals transmitted from the IC tag 1.

The IC tag 1 demodulates the received radio signals and executes processing based on the received data included therein. The IC tag 1 transmits a reply to the received data to the reader/writer 2. The IC tag 1 of the present embodiment is a passive type IC tag 1 which has no internal power supply, and where the IC chip 10 and the antenna are integrated.

As described above, the IC tag 1 transmits the radio signals, including the reply to the received data as data, to the reader/writer 2. According to this embodiment, signals called a sub-carrier are superimposed on the radio signals for transmitting the data from the IC tag 1 to the reader/writer 2. First the sub-carrier in the present embodiment will be described.

In the present embodiment, when data is transmitted from the IC tag 1 to the reader/writer 2, the signals acquired by modulating the carrier based on the ASK (Amplitude Shift Keying) are transmitted. This ASK modulation is a type of amplitude modulation. If the frequency of the carrier is fc and the frequency of the data is fd, the frequency spectrum of the amplitude-modulated signals have distribution of which the peaks are fc (carrier), fc−fd (lower side band) and fc+fd (upper side band). When data is acquired from the modulation signals having a frequency in this frequency spectrum, data is acquired from the frequency band with fc−fd (or fc+fd) as a center based on the data. Therefore normally only frequency components corresponding to the distribution with fc−fd (or fc+fd) as a center are passed using such filters as LPF (or HPF), and data is demodulated.

Here the case when the frequency fd of the data is extremely low will be considered. In the frequency spectrum of amplitude-modulated signals in this case, the space between fc−fd and fc+fd becomes smaller since fd is a small value. In other words, the space between the lower side band and the upper side band becomes smaller. If the space between the lower side band and the upper side band becomes smaller, LPF (or HPF), for passing the signals with frequency components with the fc−fd (or fc+fd) as the center, must have a sharp characteristic as a filter. As this space becomes smaller, demodulating data with appropriately separating the lower side band and the upper side band becomes difficult.

With the foregoing in view, a signal called a sub-carrier is used if the frequency fd of the data is extremely lower than the frequency fc of the carrier. This is a signal having a frequency fs that can separate the lower side band and the upper side band of the frequency of the carrier.

If a sub-carrier is used, a first modulation signal acquired by modulating the sub-carrier is generated based on the data. Then a second modulation signal for modulating the carrier by this first modulation signal for transmission is generated. By this, the lower side band and the upper side band can be separated for certain when the data is demodulated, and data can be demodulated accurately.

The radio signals to be output from the IC tag 1 to the reader/writer 2 in this embodiment is data of the ASK-modulated carrier, and are radio signals having the above described sub-carrier component. The IC tag 1 to be used in this embodiment will now be described. This IC tag 1 modulates the sub-carrier by the data to be transmitted to the reader/writer 2, as described above, and modulates the carrier by this modulated sub-carrier.

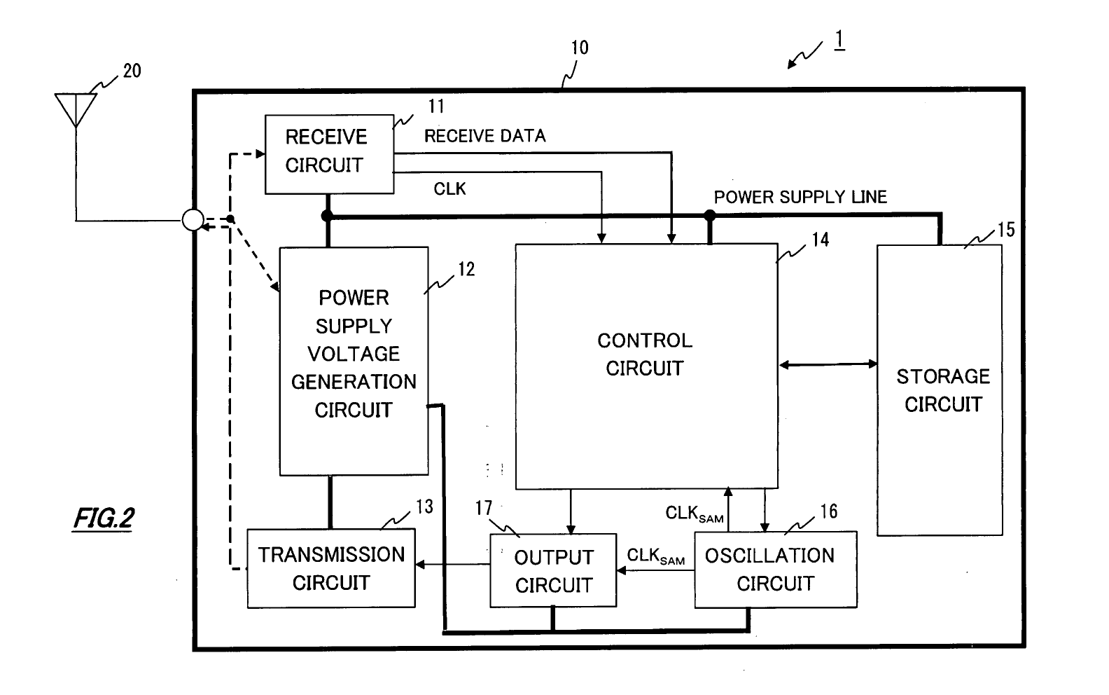

FIG. 2 is a block diagram depicting the IC tag 1 of the present embodiment. As FIG. 2 shows, the IC tag 1 comprises the antenna 20 and the IC chip 10. The antenna 20 is for communicating with the reader/writer 2. The IC chip 10 is a semiconductor device for storing and reading the communicated data and creating the radio signals to be transmitted.

This IC chip 10 comprises a receive circuit 11, power supply voltage generation circuit 12, transmission circuit 13, control circuit 14, storage circuit 15, oscillation circuit 16 and output circuit 17.

The receive circuit 11 is a circuit for generating receive data by demodulating the radio signals received by the antenna 20. In the receive circuit 11, reference clocks CLK for the control circuit 14 to operate are generated from the radio signals, and are supplied to the control circuit 14. The power supply voltage generation circuit 12 is a circuit for generating the power supply voltage from the radio signals received by the antenna. The transmission circuit 13 is a circuit for modulating the transmission data as the radio signals to be sent to the reader/writer 2. The control circuit 14 is a circuit for performing writing and reading for the storage circuit 15 and other logical processing according to a command received from the reader/writer 2. This control circuit 14 also includes a charge pump circuit for receiving clocks generated in the oscillation circuit 16, and generating voltages for writing data in the storage circuit 15, although this is not illustrated. The storage circuit 15 is a circuit comprised of a non-volatile memory, such as an EEPROM, for holding identification information and data sent from the reader/writer 2. The oscillation circuit 16 is a circuit comprised of a ring oscillator, for example, for generating predetermined frequency clocks (hereafter called sampling clocks CLK_{SAM}), which are different from the above mentioned reference clocks CLK. These sampling clocks CLK_{SAM} are used as the above mentioned sub-carrier, and are also supplied to the charge pump circuit which generates high voltage for writing data to the storage circuit 15. The frequency fs of the sampling clocks CLK_{SAM} is determined based on the frequency fc of the carrier and the frequency of the data. In the present embodiment, the carrier is 2.45 GHz and the frequency of the data is about 20 KHz, so the frequency fs of this sampling clock CLK_{SAM} is set to 400 KHz. The output circuit 17 generates pulses for modulation from the transmission data to be sent from the IC tag 1 to the reader/writer 2 and the sampling clocks CLK_{SAM}, and outputs them to the transmission circuit 13.

Now the operation of the IC tag 1 constructed like this will be described. This IC tag 1 receives radio signals from the reader/writer 2 by the antenna 20. The received radio signals are input to the IC chip 10. In the receive circuit 11, the receive data and the reference clock CLK are acquired from the carrier and data included in the radio signals, and are output to the control circuit 14. The control circuit 14 performs reading and writing for the storage circuit 15 based on the received data, and outputs the transmission data to the output circuit 17 if there is data to be transmitted to the reader/writer 2.

In the output circuit 17, the sampling clocks CLK_{SAM} are converted into pulses for modulation based on the transmission data, and are output to the transmission circuit 13. In the transmission circuit 13, the carrier is modulated based on the pulses for modulation by the later mentioned modulation circuit, to generate the ASK-modulation signals where the carrier, sub-carrier and data are superimposed. This signal is sent to the reader/writer 2 as a radio signal via the antenna 20.

The above mentioned series of operations of the IC tag 1 are performed by the power supply voltage generated by the power supply voltage generation circuit 12. The above mentioned sampling clocks are clocks generated by a free-running oscillator created in the oscillation circuit 16.

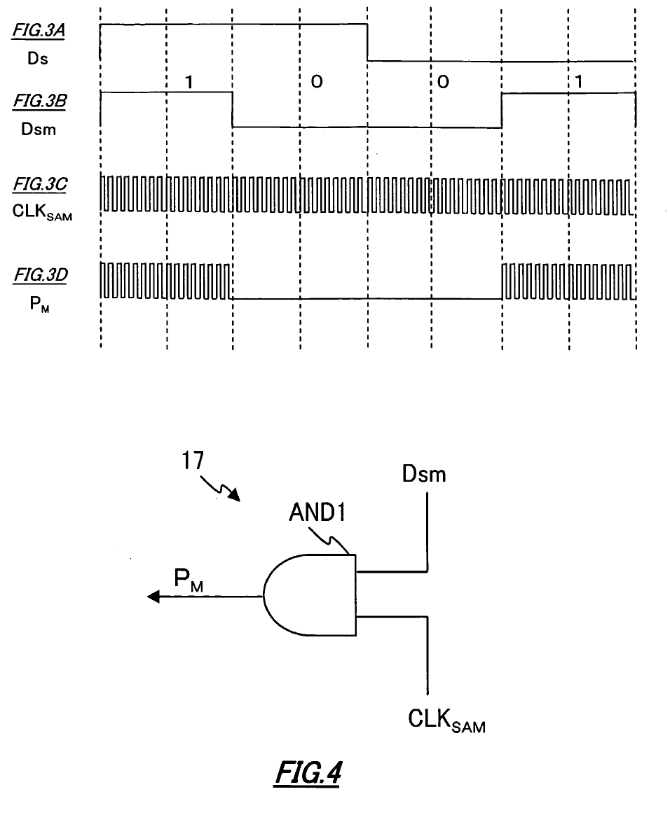

Now details on the transmission data format and the radio signals to be transmitted from the IC tag 1 to the read/writer 2 will be described. FIG. 3 is a diagram depicting the waveforms of data to be used for the present embodiment.

In IC tag 1, data on individual information, for example, may have to be transmitted to the reader/writer 2 based on a command from the reader/writer 2. In this case, necessary transmission data Ds is read from the storage circuit 15 by the control circuit 14.

The transmission data Ds read here is encoded by the control circuit 14, using a method called Manchester encoding, and becomes Manchester-encoded transmission data Dsm. FIG. 3A shows the normal binary transmission data Ds, and FIG. 3B is the transmission data Dsm after Manchester encoding is performed on the transmission data Ds. As FIG. 3A and FIG. 3B show, the Manchester encoding is an encoding method for designating a bit where the signal falls in the middle of the bit (from “H” to “L”) as “1”, and a bit where the signal rises in the middle of the bit (from “L” to “H”) as “0”. In other words, the Manchester encoded transmission data Dsm is data acquired by representing original data using a double bit (or frequency).

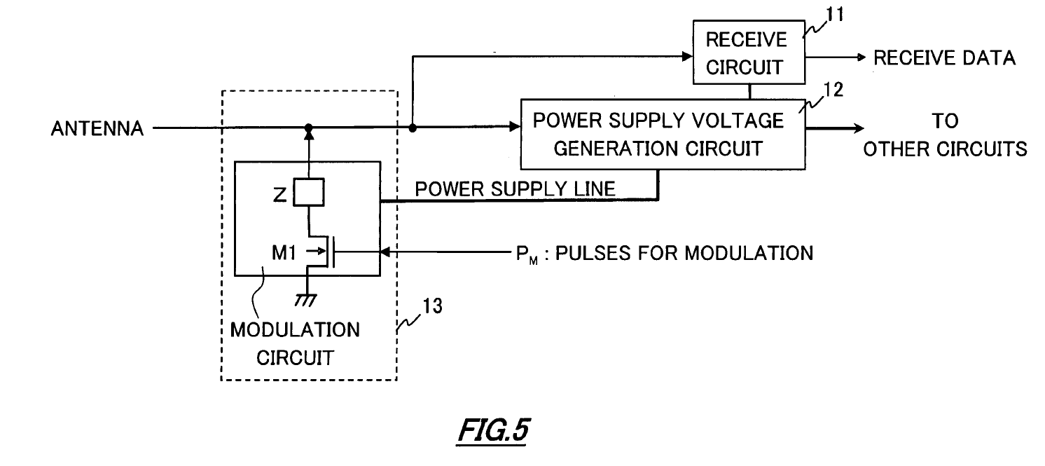

In this way, the Manchester-encoded transmission data Dsm is serial data, and is input to the output circuit 17. FIG. 4 is a diagram depicting a part of the configuration of the circuits of this output circuit 17. As FIG. 4 shows, this output circuit 17 has the logical AND gate AND1. The above mentioned Manchester-encoded transmission data Dsm is input to one of the input terminals of this AND gate AND1, and sampling clocks CLK_{SAM} (see FIG. 3C) are input to the other input terminal.

The output circuit 17 outputs the pulse for modulation P_{M} acquired by determining the AND of the Manchester-encoded transmission data Dsm, and the sampling clocks CLK_{SAM} (see FIG. 3D). In other words, a component of the sub-carrier is superimposed on the data by the output circuit 17. This pulse for modulation P_{M} is input to the modulation circuit created in the transmission circuit 13.

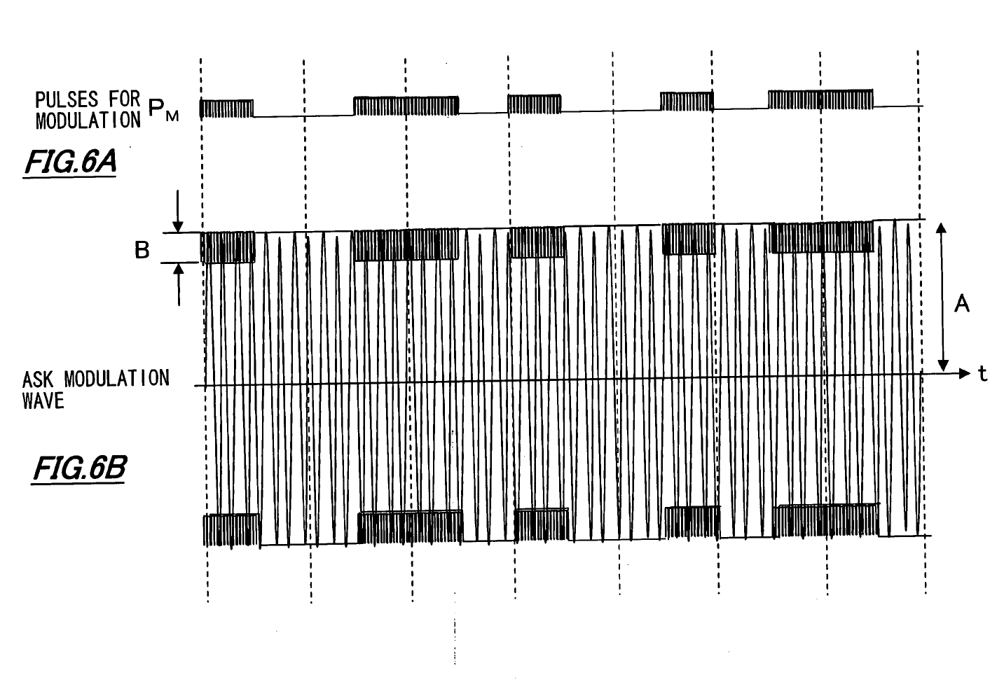

FIG. 5 is a circuit diagram depicting the modulation circuit included in the transmission circuit 13. This modulation circuit comprises the MOS transistor M1 and the impedance Z. One terminal of the impedance Z is connected to the antenna, and the other terminal is connected to the drain of the MOS transistor M1. The gate of the MOS transistor M1 is connected to the output circuit 17, and the source is connected to the ground potential. Here the pulses for modulation P_{M}, generated by the output circuit 17, are supplied to the gate electrode of the MOS transistor M1. This modulation circuit performs the switching operation of the MOS transistor M1 according to the voltage of the pulses for modulation P_{M} supplied from the output circuit 17. When the MOS transistor M1 is in OFF status, this impedance Z is not applied as a load, but when the MOS transistor is in ON status, the impedance Z is applied to the antenna 20 as the load. By this, the voltage generated in the antenna changes, and substantially this means that an ASK modulation was performed on the amplitude of the carrier by the pulses for modulation P_{M}.

FIG. 6 is a diagram depicting the relationship between the ASK modulation wave modulated by the operation of this modulation circuit and the pulses for modulation P_{M} to be input to the modulation circuit. When the pulses for modulation P_{M} shown in FIG. 6A are input to the gate of the MOS transistor M1, the ASK modulation wave (radio signals) to be transmitted from the antenna 20 becomes the modulation wave as shown in FIG. 6B. In other words, the carrier becomes the modulated signals by the pulses for modulation P_{M} which were input, and the modulated signals are transmitted

Here it is assumed that the amplitude of the carrier is A, and the amplitude of the portion of the carrier modulated by the pulses for modulation is B (see FIG. 6B). The value of amplitude B can be changed by changing the load Z in FIG. 5. ASK modulation is a modulation system for representing the presence of data by changing the amplitude of the carrier. Therefore as a data receiving side, the presence of data can be detected and the data can be acquired more easily as the degree of modulation increases. Therefore generally the demodulation of data becomes easier as value B is increased and the degree of modulation is increased. However in the present embodiment, a passive type IC tag for generating power supply voltage from the carrier of the radio signals is used. If the value of the amplitude B is increased in order to increase the degree of modulation in this passive type IC tag, large power is consumed for control thereof. In the case of a passive IC tag which can use only limited power, it is preferable that the degree of modulation for B/A is small, so as to minimize the power to be used for modulation. So according to the present embodiment, a value to be A>>B is selected, and the degree of modulation is set to be 10% or less, for example.

As the above description shows, according to the IC chip 10 of the present embodiment, the transmission data Ds is Manchester-encoded (Dsm), and the pulses for modulation P_{M} are acquired by modulating the sampling clock using this data Dsm. The carrier is then modulated by these pulses for modulation P_{M}, and is transmitted as an ASK modulation wave (radio signals) to be transmitted from the IC tag 1. Therefore the radio signals to be transmitted from the IC tag 1 to the reader/writer 2 are radio waves where the transmission data, carrier and sub-carrier are superimposed.

FIG. 7 is a diagram depicting the frequency spectrum of the ASK modulation wave generated as described above. As described above, the sampling clocks CLK_{SAM} are used as the sub-carrier here. So if the frequency of the carrier is fc (2.45 GHz) and the frequency of the sampling clocks is fs (400 KHz), then the frequency spectrum including the data centers on fc±fs. Since this sub-carrier has been modulated based on the transmission data Ds, the data to be transmitted from the IC tag 1 to the reader/writer 2 is superimposed on these two side bands. Also since the 400 KHz sampling clocks generated in the oscillation circuit 16 are used as the sub-carrier, the space between the upper side band and the lower side band do not become very small.

Therefore if the transmission data Ds is demodulated from the radio signals transmitted from the IC tags 1 by the reader/writer 2, the data transmitted from the IC tag 1 has the frequency spectrum shown in FIG. 7. In this case, the signals corresponding to the data are included in both the side bands of the spectrum centering on fc±fs. Therefore in the reader/writer 2 side, only the signals at the fc−fs side are passed by LPF (or fc+fs side by HPF), and the content of the transmitted data is demodulated by synchronous detection with the frequency fs of the sub-carrier.

As described above, according to the present embodiment, the self-oscillating oscillation circuit 16 created in the IC chip 10 generates the sampling clocks CLK_{SAM} corresponding to the sub-carrier. These sampling clocks CLK_{SAM} are superimposed by the output circuit 17, and become the pulses for modulation P_{M}. Also by transmitting the radio signals, where the carrier, sub-carrier and transmission data are superimposed, from the IC tag 1 by the modulation circuit, appropriate demodulation can be performed by the reader/writer 2 side.

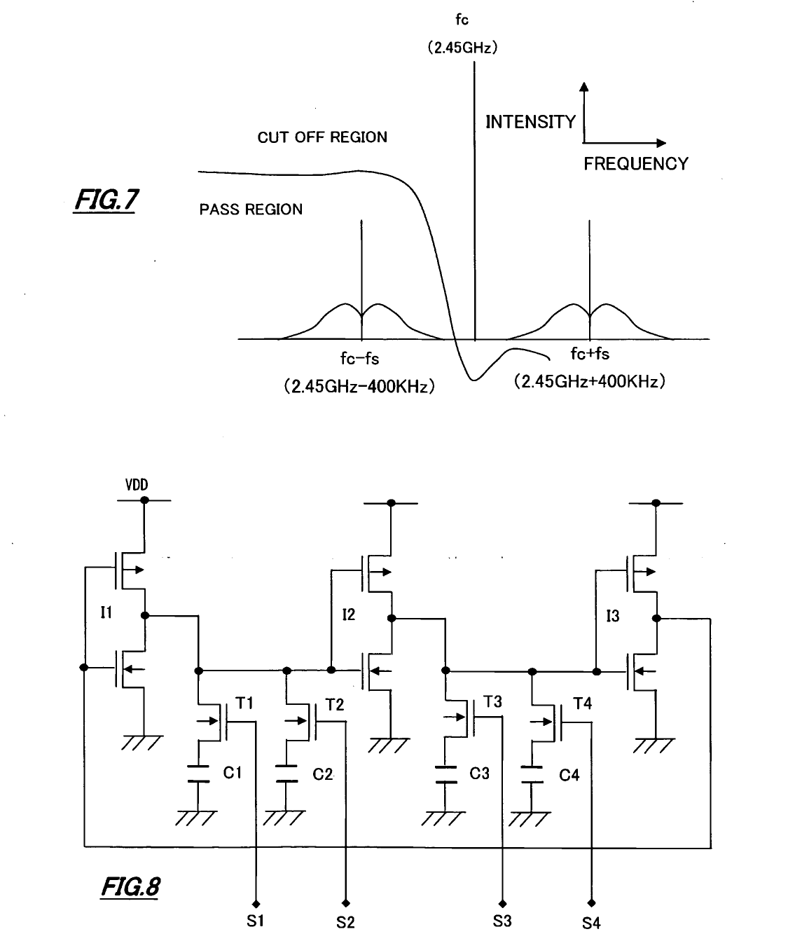

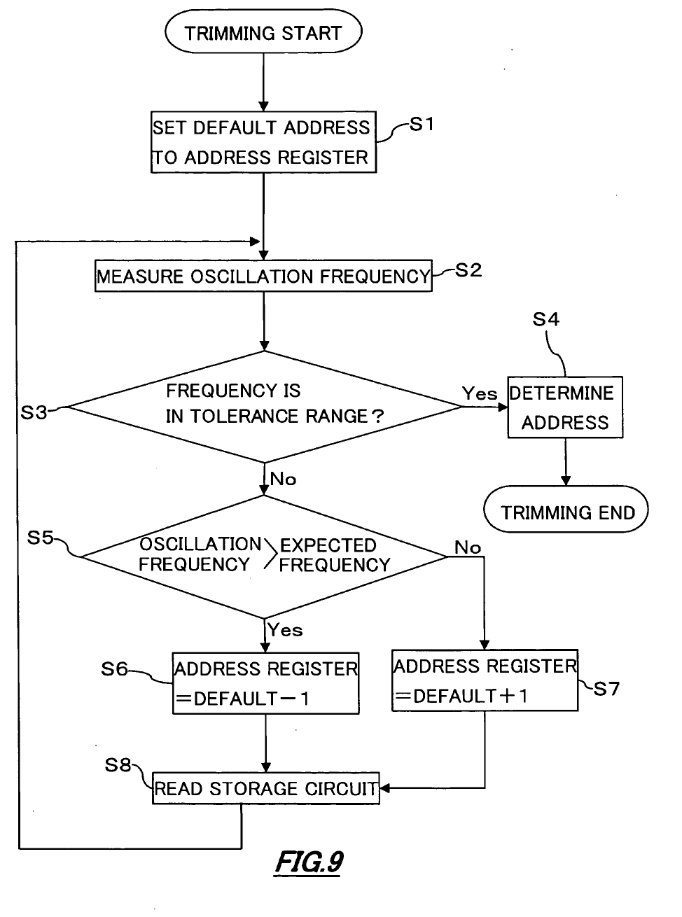

Now the circuit for generating the sampling clocks CLK_{SAM} corresponding to the sub-carrier according to the present embodiment will be described. FIG. 8 is a circuit diagram depicting an example of the oscillation circuit 16 for generating the sampling clocks CLK_{SAM}. This oscillation circuit 16 is a ring oscillator comprised of three inverters I1, I2 and I3. Such a ring oscillator may not accurately oscillate at a frequency which was set in designing (frequency corresponding to sub-carrier) due to manufacturing dispersion. Therefore this ring oscillator has the following configuration. The transistor T1 and the capacitor C1 are connected in series, between the node, which is between the inverters I1 and I2, and the ground potential. In parallel with this transistor T1 and capacitor C1, the transistor T2 and the capacitor C2 are connected in the same way, which are between the node and the ground potential. The node, which the transistor T2 is connected, is between the inverters I1 and I2. The transistor T3 and the capacitor C3 are connected in series, between the node, which is between the inverters I2 and I3, and the ground potential. In parallel with this transistor T3 and the capacitor C3, the transistor T4 and the capacitor C4 are connected in the same way, which are between the node and the ground potential. The node, which the transistor T4 is connected, is between the inverters I2 and I3. The gate electrodes of the transistor T1, T2, T3 and T4 are connected to the trimming terminals S1-S4 respectively.

If a signal indicating “1” is input to the trimming terminal S1 here, the transistor T1 turns ON. Therefore the capacitor C1 is connected to the output node of the inverter I1. If a signal indicating “0” is input to the trimming terminal S1, on the other hand, the transistor T1 turns OFF. Therefore the capacitor C1 is not connected to the output node of the inverter I1. For the trimming terminals S2-S4 as well, the connection/disconnection of the capacitors C2-C4 is determined depending on the signal to be input to the trimming terminals S2-S4 respectively.

The ring oscillator shown in FIG. 8 can change the capacitance to be connected to the respective node by the ON/OFF of the transistors T1-T4. In other words, the oscillation frequency thereof can be adjusted by the ON/OFF of the transistors T1-T4. A signal can be provided to the trimming terminals S1-S4, which determine the ON/OFF of each transistor, so as to oscillate at a frequency corresponding to the sub-carrier.

Now the method thereof will be described. To make understanding easier, the case of S1=1, S2=0, S3=0, S4=0 is represented with “1000”, then in the case of the circuit shown in FIG. 8, there are 16 combinations of the signals S1-S4, that is “0000”-“1111”. The data of each combination is held in the EEPROM of the storage circuit 15.

This IC chip 10 has a memory address register in the storage circuit 15, and in the initial status, the address of the EEPROM which provides the combination of “1000”, for example, is stored in the trimming terminals S1-S4. At testing when the IC chip 10 is created, the oscillation frequency of the oscillation circuit 16 is measured with which the address shown in this memory address register is overwritten, then the oscillation frequency can be adjusted with an arbitrary combination for the trimming terminals S1-S4.

FIG. 9 is a flow chart depicting the method for deciding the address that is written in the memory address register.

In the stage when the trimming started, the default address (e.g. address indicating “1000”) has been written in the memory address register (step S1). When trimming starts, the oscillation circuit starts oscillation and the oscillation frequency thereof is measured by the tester (step S2). The tester judges whether the measured oscillation frequency is in the tolerable range to be used as the sub-carrier (step S3).

If the measured frequency is in the tolerable range, it is regarded that the free-running oscillator in the IC chip 10 is oscillating at an accurate frequency, and the test is ended (step S4).

When the measured frequency is outside the tolerable range, the tester judges whether the measured frequency is higher or lower than the expected oscillation frequency in the tolerable range (step S5).

When the measured frequency is higher than the expected oscillation frequency, the tester decrements the address written in the memory address register by one, for example (step S6). The combination of S1-S4 written in the decremented address is a combination for decreasing the oscillation frequency of the oscillation circuit 16 one stage lower than the current oscillation frequency.

When the measured frequency is lower than the expected oscillation frequency, the tester increments the address written in the memory address register by one (step S7). The combination of signals S1-S4 written in the incremented address is a combination of increasing the oscillation frequency of the oscillation circuit 16 one stage higher than the current oscillation frequency.

By changing the address written in the memory address register, the oscillation circuit reads signals based on the data written in the new address of the storage circuit 15. Signals based on this data are supplied to the trimming terminals S1-S4 (step S7).

After the signals supplied to the trimming terminals S1-S4 change, the processing returns to step S2, and the tester measures the frequency oscillated by the oscillation circuit again.

Then this process is sequentially repeated, and when the measured frequency comes within the tolerable range, overwriting the content of the memory address register is ended, and trimming is completed.

Since overwriting of the register is ended when the oscillation frequency of the oscillation circuit comes into a range to be applied as the sub-carrier, the oscillation circuit 16 created in the IC chip 10 can operate as a circuit which has a stable oscillation frequency.

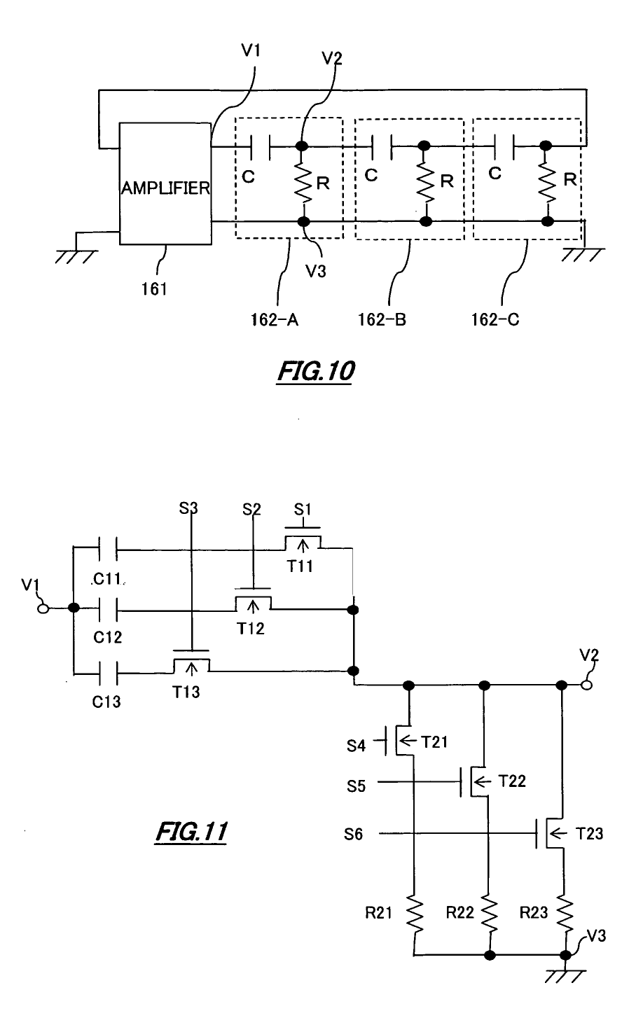

FIG. 10 is a circuit diagram depicting another example of the oscillation circuit 16 according to the present embodiment. As FIG. 10 shows, this example shows a CR oscillation circuit using the amplification circuit 161 and three stages of phase shift circuits 162-A-162-C. The description of the oscillation operation of this CR oscillation circuit, which is well known, will be omitted here. In the case of the oscillation circuit shown in FIG. 10, the oscillation frequency f thereof will be given by the following expression.
f=1/(2π6^{1/2}CR)

In other words, the oscillation frequency f is set by the capacitance value C and the resistance value R. So in the CR oscillation circuit of the present embodiment, the phase shift circuit of each stage is created to be the phase shift circuit shown in FIG. 11. To describe FIG. 11, it is assumed that in the phase shift circuit 162-A in FIG. 10, the terminal of the capacitor C to be connected to the amplification circuit 162 is V1, the node between the capacitor C and the resistor R is V2, and the terminal connected to the ground potential of the resistor R is V3.

As FIG. 11 shows, the phase shift circuit in the first stage has the capacitor C11 and the MOS transistor T11, the capacitor C12 and the MOS transistor T12, and the capacitor C13 and the transistor T13, which are connected in series between the nodes V1 and V2 in FIG. 10. Here the capacitors C11-C13 are connected in parallel. In other words, the capacitor C of the phase shift circuit in FIG. 10 is divided into the capacitor C11-C13, to which the MOS transistors T11-T13 to be switches are connected respectively. The resistor R is also divided just like the capacitor C. In other words, the resistor R21 and the MOS transistor T21, the resistor R22 and the MOS transistor T22, and the resistor R23 and the MOS transistor T23, which are connected in series, are between the nodes V2 and V3. Here the resistors R21-R23 are connected in parallel. The gate electrodes of the MOS transistors T11-T13 are connected to the trimming terminals S1-S3, and the gate electrodes of the MOS transistors T21-T23 are connected to the trimming terminals S4-S6.

In other words, the connection/disconnection of each capacitor C11-C13 and the resistors R21-R23 is determined by the potential applied to the trimming terminals S1-S6.

Just like the case of the ring oscillator shown in FIG. 8, the capacitance value C and the resistance value R of the phase shift circuits 162-A-162-C shown in FIG. 10 are changed by changing the signals to be supplied to the trimming terminals S1-S6. As a result, the oscillation frequency given by the above mentioned expression also changes, so the oscillation frequency of the CR oscillation circuit can be adjusted. FIG. 11 shows a configuration of one stage phase shift circuit (162-A), but this is the same for the other phase shift circuits 162-B-162-C. Here it is assumed that each phase shift circuit has an identical configuration and the same signal is supplied to the trimming circuits, since the capacitance C and the resistance R are the same for the phase shift circuit of each stage in the CR oscillation circuit in FIG. 10.

Here the method for determining the signals to be supplied to the trimming terminals S1-S6 is very similar to the method in the ring oscillator shown in FIG. 9. In other words, a combination of signals as a default is supplied to the trimming terminals S1-S6 by the tester. The oscillation frequency, as a result, is measured, and the combination of signals to be supplied to the trimming terminals S1-S6 is changed based on the measurement result. As a result of sequential overwriting, the combination of signals which finally came into the tolerable range is stored as the sampling clock, and trimming is ended.

As described above, according to this embodiment, the oscillation circuit 16 is installed inside the IC chip 10 of the IC tag 1, and the clock to be output by this oscillation circuit 16 is used as the sub-carrier, so transmission radio waves, that can be stably demodulated by the reader/writer, can be generated without installing a divider inside the IC chip 10.

In the above embodiment, using clocks generated by the oscillation circuit as the sub-carrier was described, but the clocks generated by the oscillation circuit can also be used as the clocks for the charge pump circuit which is used for writing the storage circuit.

The control circuit 14 does not operate the oscillation circuit based on the receive data unless data is written to the storage circuit or unless data is transmitted to the reader/writer, so that the power for the IC tag 1 to consume can be decreased.

It is apparent that the present invention is not limited to the above embodiment and it may be modified and changed without departing from the scope and spirit of the invention.

What is claimed is:

1. A semiconductor device, comprising:
a receive circuit for generating receive data from received radio signals;
a power supply voltage generation circuit for generating power supply voltage based on the received radio signals;
a control circuit for performing logical processing based on the received data;
a transmission circuit for generating radio signals including transmission data and transmitting the radio signals via an antenna; and
an oscillation circuit, which is operated using the power supply voltage generated by the power supply voltage generation circuit, for generating a predetermined frequency of clocks.

2. The semiconductor device according to claim 1, wherein the predetermined frequency is a frequency lower than that of a carrier of the radio signals including the transmission data.

3. The semiconductor device according to claim 1, further comprising an output circuit for outputting pulses for modulation acquired by modulating the clocks of the predetermined frequency according to the transmission data.

4. The semiconductor device according to claim 3, further comprising a modulation circuit for generating the radio signals including the transmission data by modulating the carrier using the pulses for modulation.

5. The semiconductor device according to claim 4, wherein the modulation circuit performs ASK modulation on the carrier using the pulses for modulation.

6. The semiconductor device according to claim 5, wherein a degree of modulation of the ASK modulation is controlled by changing a load connected to the antenna.

7. The semiconductor device according to claim 1, wherein the oscillation circuit comprises a ring oscillator to which an odd stage of an inverter is connected.

8. The semiconductor device according to claim 7, wherein the oscillation circuit further comprises a capacitor and a switch element connected in series between at least one output node of the inverter constituting the ring oscillator and a fixed potential.

9. The semiconductor device according to claim 7, wherein the oscillation circuit further comprises a first capacitor and a first switch element connected in series between an output node of a first inverter constituting the ring oscillator and a fixed potential, and a second capacitor and a second switch element connected in series between an output node of a second inverter constituting the ring oscillator and a fixed potential.

10. The semiconductor device according to claim 1, wherein the oscillation circuit is a CR oscillation circuit.

11. The semiconductor device according to claim 1, wherein the receive circuit further generates reference clocks from the received radio signals and supplies the reference clocks to the control circuit.

12. An IC tag which communicates with a reader/writer and operates based on radio signals transmitted from the reader/writer, comprising:
a receive circuit for generating receive data from the radio signals received from the reader/writer;
a power supply voltage generation circuit for generating power supply voltage based on the received radio signals;
a storage circuit for storing information;
a control circuit for controlling the reading/writing of the storage circuit based on the received data;
a transmission circuit for transmitting the information read from the storage circuit to the reader/writer as transmission data; and
an oscillation circuit for generating a predetermined frequency of clocks.

13. The IC tag according to claim 12, wherein the predetermined frequency is a frequency lower than that of a carrier of the radio signals including the transmission data.

14. The IC tag according to claim 12, further comprising an output circuit for outputting pulses for modulation acquired by modulating the clocks of the predetermined frequency according to the transmission data.

15. The IC tag according to claim 14, further comprising a modulation circuit for generating the radio signals including the transmission data by modulating the carrier using the pulses for modulation.

16. The IC tag according to claim 15, wherein the modulation circuit performs ASK modulation on the carrier using the pulses for modulation.

17. The IC tag according to claim 16, wherein a degree of modulation of the ASK modulation is controlled by changing a load connected to an antenna.

18. The IC tag according to claim 12, wherein the oscillation circuit comprises a ring oscillator to which an odd stage of an inverter is connected.

19. The IC tag according to claim 18, wherein the oscillation circuit further comprises a capacitor and a switch element connected in series between at least one output node of the inverter constituting the ring oscillator and a fixed potential.

20. The IC tag according to claim 12, wherein the oscillation circuit further comprises a CR oscillation circuit.
